(19) United States
(12) Patent Application Publication
(10) Pub. No.: US 2016/0140577 A1
(43) Pub. Date: May 19, 2016

(54) UNIFIED MARKETING MODEL BASED ON CONDUIT VARIABLES

(71) Applicant: Neil Morley, Santa Monica, CA (US)

(72) Inventor: Neil Morley, Santa Monica, CA (US)

(21) Appl. No.: 14/543,613

(22) Filed: Nov. 17, 2014

(51) Int. Cl. G06Q 30/02

(52) U.S. Cl. CPC G06Q 30/0201

(57) ABSTRACT

A unified model system for constructing a unified marketing model based on contributing models is provided. The unified model system generates conduit variables from the contributing models by applying each contributing model to the values of input parameters to generate corresponding values output parameters of the contributing mode. The unified model system then generates metrics from the input parameters and the values of the output parameters where metrics correspond to the conduit variable from the contributing models. The unified model then generates the unified marketing model based at least in part on the generated conduit variables from the contributing models and a mapping of values of input parameters of the contributing models for individual consumers to marketing scores for the individual consumers. The unified marketing model can then be used to assist in the analysis of marketing activities.

### CROSS-REFERENCE TO RELATED APPLICATIONS

This application is related to U.S. patent application Ser. No. 13/204,585, filed Aug. 5, 2011, U.S. patent application Ser. No. 12/390,341, filed Feb. 20, 2009, which claims the benefit of the following U.S. Provisional Patent Application Nos. 1) 61/030,550, filed Feb. 21, 2008; 2) 61/084,252, filed Jul. 28, 2008; 3) 61/084,255, filed Jul. 28, 2008; 4) 61/085,819, filed Aug. 1, 2008; and 5) 61/085,820, filed Aug. 1, 2008, U.S. patent application Ser. No. 12/366,937, filed Feb. 6, 2009, U.S. patent application Ser. No. 12/366,958, filed Feb. 6, 2009, U.S. patent application Ser. No. 12/692,577, filed Jan. 22, 2010, which claims the benefit of U.S. Provisional Patent Application No. 61/146,605, filed Jan. 22, 2009, U.S. patent application Ser. No. 12/692,579, filed Jan. 22, 2010, which claims the benefit of U.S. Provisional Patent Application No. 61/146,605, filed Jan. 22, 2009, U.S. patent application Ser. No. 12/692,580, filed Jan. 22, 2010, which claims the benefit of U.S. Provisional Patent Application No. 61/146,605, filed Jan. 22, 2009, and U.S. patent application Ser. No. 12/609,440, filed Oct. 30, 2009. All of the above-identified patent applications are incorporated in their entirety herein by reference.

### BACKGROUND

Marketing communication (“marketing”) is the process by which sellers of offerings (e.g., products or services) educate potential purchasers or consumers about the offerings through, for example, the dissemination of advertisements or marketing messages. Sellers can market to potential purchasers through various marketing media as using Internet, the radio, an outdoor display, television (e.g., cable, broadcast, and satellite), video games, print (e.g., newspaper and magazines), cell phones (e.g., text messages), and email. Sellers can market through these marketing media using various marketing techniques, such as direct marketing, promotions, product placement, and so on. Furthermore, each marketing medium may include multiple types of marketing or advertising channels (e.g., marketing outlets or touchpoints) such as advertising networks, advertising exchanges, search engines, websites, online video sites, television networks, television programs, timeslots for each television network, and so on. Furthermore, each of these marketing channels may comprise more granular channels or “sub-channels,” such as individual advertising networks, individual advertising exchanges, individual search engines, individual online video sites, individual television networks, individual programs, or timeslots for each television network, and so on.

The proliferation of multiple new and unique media channels (especially online channels) has made the task of assessing the relationship between marketing efforts, marketing channels, and user behavior difficult. Because of the difficulty, the process of developing a marketing plan for a seller can be complex as it involves analyzing historical marketing efforts and their effectiveness, allocating a level of spending to each of a number of marketing media and/or marketing channels, assessing the performance or effectiveness of those allocations, and so on. Although there are a few automated decision support tools to assist a seller in developing a marketing plan, many sellers find these tools to be of limited usefulness. For example, some sellers perform several separate analyses (e.g., marketing mix modeling, propensity scoring, customer segmentation, in-market testing, and digital attribution) of marketing effectiveness at different levels of data aggregation, but do not have the tools or processes to reconcile conflicting results or bring partial results together into a single solution. As a result, sellers often perform these activities manually, relying on subjective conclusions, and in many cases producing disadvantageous results.

Analyzing consumer decisions can be very complex, in part, because consumers are influenced by a variety of decision factors, such as those that are intrinsic to the individual consumer (e.g., demographics, prior experiences), deliberate actions of marketers (e.g., product placement, advertisements), and aspects of various social and economic environments (e.g., trends, friends and family preferences). In some cases, decision factors influencing consumers can be traced to individual consumers while some can only be traced to consumers in the aggregate (e.g., a segment or a market). For example, if a direct email or text messaging marketing campaign results in a consumer receiving an advertisement, clicking on a link in the advertisement, and making a purchase, that consumer's purchase can be traced to the marketing campaign. As another example, if a television marketing campaign results in a consumer viewing a television advertisement and as a result purchasing the advertised product on the next visit to a store, that consumer's purchase cannot be traced to the television advertisement. However, if purchases of the advertised product increase after running the television advertisement, the consumers' purchases in the aggregate can be considered to have been influenced by the television advertisement.

Predicting consumer decisions is not only based on analyzing consumer decision factors, but also on actions taken by the consumer. For example, performing a particular web search, visiting a particular website, participating in a trial or consultation, and so on, can be used to reveal information about the intentions and potential future decisions of a consumer. If a consumer visits a website for a product, the consumer is more likely to purchase that product than the more general consumer who has not visited that website. The consumer's visit to that website reveals something about the intention of the consumer.

Although tools are available to assist in analyzing and predicting consumer decisions, each tool bases it analysis on very different types of data (e.g., consumer demographics and advertisement placements). As described above, the tools can provide conflicting results, which can be difficult to reconcile.

### BRIEF DESCRIPTION OF THE DRAWINGS

FIG. 1 is a block diagram illustrating the generation of a unified marketing model in some embodiments.

FIG. 2 is a block diagram of components of the unified model system in some embodiments.

FIG. 3 is a flow diagram that illustrates the processing of a generate propensity conduit variable component of the unified model system in some embodiments.

FIG. 4 is a flow diagram that illustrates the processing of a generate marketing mix conduit variable component of the unified model system in some embodiments.

FIG. 5 is a flow diagram illustrating the processing of a generate unified model component of the unified model system in some embodiments.

### DETAILED DESCRIPTION

A method and system for constructing a unified marketing model from conduit variables derived from contributing models are provided. In some embodiments, a unified model system generates conduit variables from each of the contributing models. A contributing model may be, for example, a propensity model, a marketing mix model, user segmentations, and/or another aggregate model. The unified model system generates a conduit variable from the output of a contributing model, but a conduit variable can be more than just the output of a contributing model. A conduit variable from a contributing model may be based on metrics derived from the output of the contributing model. For example, if a contributing model is a propensity model, then a conduit variable from the propensity model may be generated by applying the propensity model to demographic information of various consumers to generate propensity scores and then clustering the users based on similar propensity scores and demographics. For values related to the input parameters of a contributing model, the unified model system applies the contributing model to the values for the input parameters to generate a corresponding value for an output parameter of the contributing model. The unified model system then generates metrics from the input parameters and the values of the output parameters where the metrics correspond to the conduit variable from the contributing mode. After generating the conduit variables, the unified model system then generates the unified marketing model based at least in part on the generated conduit variables from the contributing models and training data that maps the values from the input parameters of the contributing models for individual consumers to the marketing scores for the individual consumers. The unified model system generates a model weight for the conduit variable from each contributing model so that the unified model accurately models the results of the training data. The unified model system thus combines the metrics represented by the conduit variables into a unified model, rather than an ensemble of the separate, disparate contributing models.

A conduit variable functions as a conduit from the contributing model to the unified marketing model. Information (i.e., metrics) derived from the contributing model becomes input for generating the unified marketing model. As an example, a marketing mix model is an equation or set of equations that predicts revenue as a function of marketing and environmental variables. A conduit variable might be the amount of incremental revenue that was driven by TV advertising as derived from performing simulations using the marketing mix model. Conduit variables may include the actual results of the contributing models, decompositions of the contributing models, a lift from market-level effects, propensity scores from various propensity models, segment identifiers from a contributing model, engagement scores for different marketing activities, and so on. For example, metrics based on the amount of time a consumer spent engaging with a particular web page or offering, the number of pages views or clickthroughs, or the number of specific activities performed within a given time period, in response to a touch or exposure to a given marketing campaign, can provide information from a contributing model to the unified marketing model through a conduit variable. As another example, a contributing model that predicts the number of searches based on an aggregate level of marketing spending and general seasonality can be used to generate a conduit variable for the unified marketing model to help determine the incremental effect of those searches on individual conversions.

The unified marketing model may be used to make recommendations and predictions to support the allocation of marketing resources by combining models that predict individual customer level decision probabilities (e.g., propensity models) with models that predict outcomes at higher levels of aggregation (e.g., marketing mix models). In some embodiments, the unified marketing model can be used to predict individual decision probabilities as a function of consumer data on an individual and/or aggregate level. For example, the unified model system may employ data for individual consumers or segments of consumers (e.g., marketing segments, national populations, and so on) when generating the unified marketing model. Furthermore, the unified model system may employ data with any level of resolution or granularity, such as geographic area, consumer segment, time (seconds, minutes, hours, days, weeks, months, years), and so on. The unified model system may generate a unified marketing model based on aggregation levels that predict various business outcomes (e.g., sales, revenue, leads) or intermediate indicator outcomes (e.g., trial downloads, calls, web visits). The unified marketing model may be used to analyze the contributing models (and/or associated data) and may be used to refine the contributing model based on insights gained from the unified marketing model. For example, the unified marketing model may indicate that a probability distribution or coefficient used in a contributing model is inaccurate. A refined contributing model can then be used to generate more accurate conduit variables resulting in a further improved unified marketing model.

The unified marketing model may be used to perform various analyses such as evaluating the effectiveness of marketing mix between touchpoints at aggregate or individual levels, determining the next best action for individuals, identifying individuals or segments to target, and so on. The unified marketing model may also be used to assign credit and determine the return on an investment for past marketing spending in order to assess its effectiveness across media channels, media campaigns, media publishers, and other attributes of the marketing (e.g., viewability, offer, and message) at the level of granularity available in the data. The assignation of credit at the individual consumer level may be based on the calculated incremental probability of conversion brought by each marketing touch and then aggregated to higher levels such as the effectiveness of a particular marketing campaign. For more aggregate models, the credit can be determined by decomposing the unified marketing model via partial derivatives for each touchpoint variable included in the unified marketing model.

The conduit variables can be backward-looking, forward-looking, or counterfactual. Backward-looking conduit variables are based on historical data and are generally used during the initial generation of the unified marketing model. Forward-looking conduit variables are based on current data or planned scenarios and are generally used to score the unified marketing model on any new data. In some examples, forward-looking conduit variables can replace backward-looking conduit variables once they have been generated to provide a more up-to-date analysis. Counterfactual or “hypothetical” conduit variables are based on hypothetical examples and are generally used to explore possible “what-if” scenarios. In some embodiments, conduit variables may be precomputed prior to use by the unified marketing model or may be determined dynamically using equations describing the output of a contributing model.

The unified model system may generate a unified marketing model using the conduit variables from several contributing models such as an “offline decomposition” conduit variable derived from a previously generated econometric contributing model. The offline decomposition conduit variable may represent the impact of offline marketing (e.g., television, print, radio) and general offline economic and seasonality conditions such as the occurrence of holidays or dependence on typical weather in an individual consumer level conversion probability model. To construct the unified marketing model, the unified model system uses a backward-looking offline decomposition conduit variable from the previously generated econometric model, which includes information about the amount and effectiveness of offline activities during a past historical period (e.g., past hour, past day, past week, past month, past quarter, past year, year-to-date). Furthermore, the backward-looking offline decomposition conduit variable is included as a term in the estimation of the individual consumer level conversion probability model to determine interrelated model coefficients.

A forward-looking or counterfactual decomposition conduit variable can be created by evaluating the econometric model given scenarios of projected marketing spending and anticipated economic conditions in a current or future period. The forward-looking decomposition conduit variable can be substituted into the unified marketing model to score new individuals or customers during a future or current time period (e.g., for purposes of predicting conversion probabilities for use in attribution, for targeting, or for determining next best action). In some examples, the attribution result comprises information about the number of successful sequences touched by various online channels at a granular level (e.g., creative, publisher, offer), the effectiveness of the sequences, and so on. Moreover, attributed values to specific online channels, such as branded paid search, can be transformed into coefficient constraints and fed back in to the contributing models to be used as priors for future estimations. To assess the impact of changing offline spend during a current or future period, a user may create and use a counterfactual offline decomposition conduit variable to feed the contributing model.

In one embodiment, the unified model may by a logit model predicting the probability of a purchase by an individual customer as a function of:
A seasonality component derived from a marketing mix model through a seasonality conduit variable;
Percentage lift from offline marketing activity derived from a marketing mix model through an offline marketing conduit variable;
Innate propensity to buy the product derived from a propensity or targeting model through a demographics conduit variable;
The recency and frequency of different online interactions with the customer; and
An engagement score for each online interaction through an engagement conduit variable.

This logit model is able to predict the probability that an individual customer will buy the product as a function of major drivers of this decision, some of them represented through aggregated, some through individual, data. The logit model using two conduit variables may be represented by the following equation:

$$ln ( \frac{p}{p - 1} ) = α + β OfflineIndex + γ PropensityIndex + \sum {ɛ}_{i} {SequenceFeature}_{i}$$

where p represents the probability of a conversion for a consumer, α, β, γ, and εᵢ represent model weights, OfflineIndex represents a conduit variable derived from the marketing mix model, PropensityIndex represents a conduit variable derived from a propensity model, and the SequenceFeature represents typical logit model features of individual users including, for example, variables based on the number, the recency and frequency of marketing activity such as web site visits, touches by display campaigns, searches, and so on.

In some embodiments, the unified model system analyzes consumer interactions with marketing or marketing campaigns and the results of those interactions, such as a sale or conversion, to generate a cross-media or cross-channel attribution model representing the true impact of cross-media and cross-channel marketing resource allocation decisions is provided. The cross-media attribution model can be used to inform future decisions regarding the cross-media and cross-channel allocation of marketing resources and to improve or optimize one or more goals linking the cross-media attribution model to a financial measure related to business outcomes or brand objectives (e.g., revenue growth, increased market share, acquisition of new customers, conversion of leads, upsell, customer retention, marketing expenditure optimization, increase in short-term and/or long-term profits, increased customer life value, etc.). Historical and real-time data can be collected to measure the performance or effectiveness of marketing campaigns with respect to one or more goals and to improve the accuracy of future recommendations for the allocation of marketing resources to marketing channels.

For example, a unified marketing model can be used, in real-time, to assess the performance of a marketing campaign for a product, such as, for example, a new shoe by collecting, matching and analyzing many different types of data and many different sources using many matching methods. Thus, if the consumer purchases the new shoe, or anything else, the facility can attribute some or all of the revenue generated by the purchase to the marketing campaign and the specific marketing channels through which the advertisements for the new shoe were presented to the consumer. Furthermore, the unified marketing model can be used to couple in the impact of conduit variables, for example, the offline decomposition discussed earlier, to include a generalized effect of offline advertising campaigns that modify the propensity to convert the population at large. Based on these attributions and the allocation of marketing resources to the individual marketing channels associated with the marketing campaign, the performance of each marketing channel can be assessed in real-time.

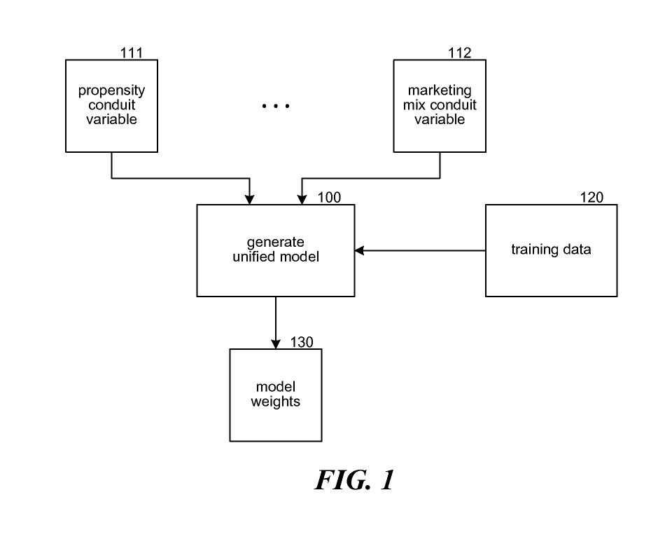

FIG. 1 is a block diagram illustrating the generation of a unified marketing model in some embodiments. A generate unified model component 100 inputs various conduit variables such as propensity conduit variable 111 and marketing mix conduit variable 112. The generate unified model component also inputs training data 120. The generate unified model component then learns the model weight for each of the conduit variables and sequence features and stores the model weights in a model weight store 130. Table 1 illustrates example data of a propensity conduit variable in some embodiments.

TABLE 1
Propensity Conduit Variable

| | Propensity | | | Avg. | Zip | | | | |
|---|---|---|---|---|---|---|---|---|---|
| Segment | Score | Loyalty | Purchaser | Visits | Code | Sex | Gamer | Sports | . . . |
| 0 | 0.54 | Y | Y | 7 | 200xx | M | Y | Y | |
| 1 | 0.25 | N | Y | 2 | 200xx | F | N | N | |
| 2 | 0.66 | Y | N | 5 | 200xx | U | Y | N | |

This propensity conduit variable represents segments or clusters of the individual propensity scores of consumers. Each row of Table 1 defines a segment including the propensity score for the segment along with the attributes of the segment. Table 2 illustrates example data of a marketing mix conduit variable in some embodiments.

TABLE 2
Marketing Mix Conduit Variable

| Time | | | | | | | | |
|---|---|---|---|---|---|---|---|---|
| Period | Region | TV | Radio | Print | Online | Email | Text | . . . |
| 0 | DC | 5% | 2% | 0% | 29% | 10% | 4% | |
| 1 | DC | 5% | 0% | 0% | 38% | 7% | 0% | |
| 2 | DC | 3% | 2% | 0% | 35% | 6% | 4% | |

The marketing mix conduit variable represents for each time period (e.g., week) and region (e.g., state), the percentage of total revenue that was attributable to each marketing channel. For example, in time period 1 for the D.C. region, 38% of the revenue was attributed to online marketing efforts (e.g., paid searches, banner ads). The marketing channels can be more finely subdivided. For example, print may be subdivided into newspaper and magazine, and online may be subdivided into banner ads and paid searches. Tables 3A and 3B illustrate example training data in some embodiments.

TABLE 3A
Training Data

| | Loy- | | | Zip | | | | |
|---|---|---|---|---|---|---|---|---|
| User | alty | Purchaser | Visits | Code | Sex | Gamer | Sports | . . . |
| A | Y | Y | 1 | 20001 | U | N | Y | |
| B | N | Y | 5 | 20003 | F | N | N | |
| C | Y | N | 2 | 20004 | U | Y | N | |
| D | Y | Y | 4 | 20009 | M | Y | Y | |

TABLE 3B
Training Data

| | | | Display | | | Social | |
|---|---|---|---|---|---|---|---|
| | | | impres- | Searches | | Media | |
| | Time | | sions | after | Affiliate | Clicks | |
| | Pe- | Con- | in last 2 | retargeting | clicks prior | in last | |
| User | riod | version | days | display | to purchase | 7 days | . . . |
| A | 1 | Y | 3 | 1 | 0 | 1 | |
| A | 2 | N | 0 | 0 | 0 | 0 | |
| A | 3 | N | 1 | 1 | 0 | 0 | |
| B | 1 | Y | 5 | 2 | 1 | 2 | |
| B | 2 | Y | 4 | 2 | 1 | 1 | |
| C | 1 | N | 1 | 1 | 0 | 1 | |
| D | 1 | N | 0 | 1 | 0 | 0 | |

Table 3A contains demographic information relating to the consumers, and Table 3B contains the conversion and sequence feature information for the consumers during various time periods. The unified model system may apply a maximum-likelihood estimation algorithm possibly using constraints or Bayesian priors to learn model weights for the conduit variables that best match the training data.

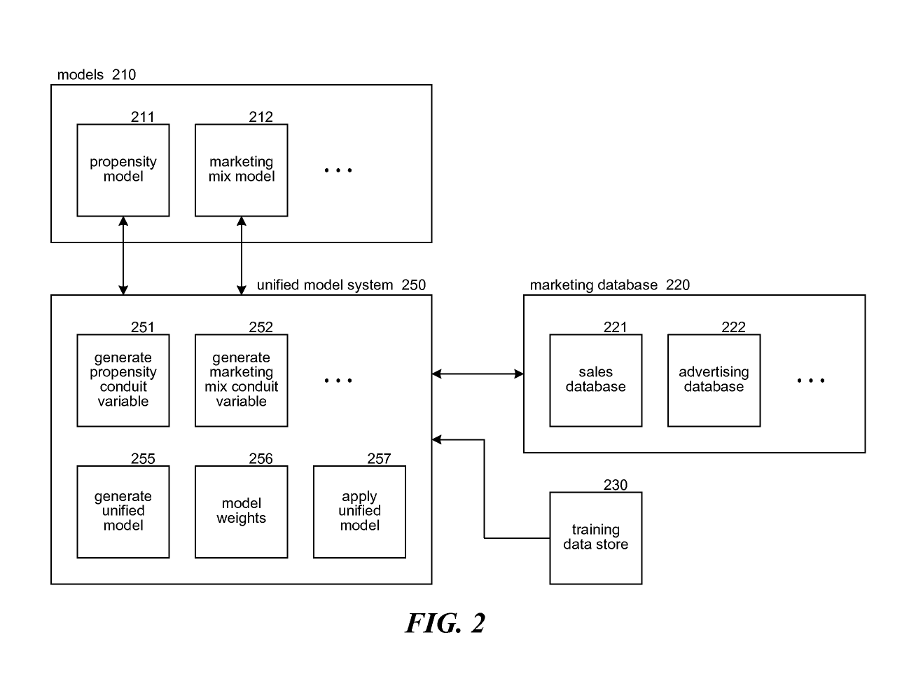

FIG. 2 is a block diagram of components of the unified model system in some embodiments. The unified model system 250 interfaces with contributing models 210, a marketing database 220, and a training data store 230. The contributing models may include a propensity model 211, a marketing mix model 212, and other models that are used by the unified model system to generate conduit variables. Tables 4A and 4B illustrate example input and output of the propensity model.

TABLE 4A
Propensity Model Input

| | Loy- | | | Zip | | | | |
|---|---|---|---|---|---|---|---|---|
| User | alty | Purchaser | Visits | Code | Sex | Gamer | Sports | . . . |
| 0 | Y | Y | 5 | 20001 | M | Y | Y | |
| 1 | N | Y | 10 | 20002 | F | N | N | |
| 2 | Y | N | 2 | 20002 | U | Y | N | |
| 3 | Y | Y | 7 | 20009 | M | N | Y | |

TABLE 4B
Propensity Model Output

| | Propensity |
|---|---|
| User | score |
| 0 | 0.5 |
| 1 | 0.3 |
| 2 | 0.1 |
| 3 | 0.7 |

Tables 5A and 5B illustrate example input and output of the marketing mix model.

TABLE 5A
Marketing Mix Model Input

| Time Period | Region | TV | Radio | Print | Online | Email | Text | . . . |
|---|---|---|---|---|---|---|---|---|
| 0 | D.C. | 25,000 | 2,500 | 0 | 60,000 | 10,000 | 2,500 | |
| 1 | D.C. | 20,000 | 0 | 0 | 75,000 | 5,000 | 0 | |
| 2 | D.C. | 10,000 | 5,000 | 5,000 | 65,000 | 10,000 | 5,000 | |

TABLE 5B
Marketing Mix Model Output

| Time | | |
|---|---|---|
| Period | Region | Revenue |
| 0 | D.C. | 1000000 |
| 1 | D.C. | 1250000 |
| 2 | D.C. | 475000 |

The marketing database may include a sales database 221, an advertising database 222, [a customer demographic database] (not illustrated), and other databases that contain information that provide input to the various contributing models and may be used to generate the training data for the training data store.

The unified model system includes a generate propensity conduit variable component 251, a generate marketing mix conduit variable component 252, and other components to generate conduit variables for the other contributing models. The unified model system also includes a generate unified model component 255 that inputs the conduit variables and training data and learns the weights for the various contributing models, which are stored in the model weights store 256. The unified model system also includes an apply unified model component 257. The apply unified model component inputs values for model parameters and generates a marketing score based on the model weights.

The computing devices and systems on which the unified model system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touchscreens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer systems such as massively parallel systems. The computing devices may access computer-readable media that includes computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the unified model system. The data transmission media is used for transmitting data via transitory, propagating signals or carrier waves (e.g., electromagnetism) via a wired or wireless connection.

The unified model system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments.

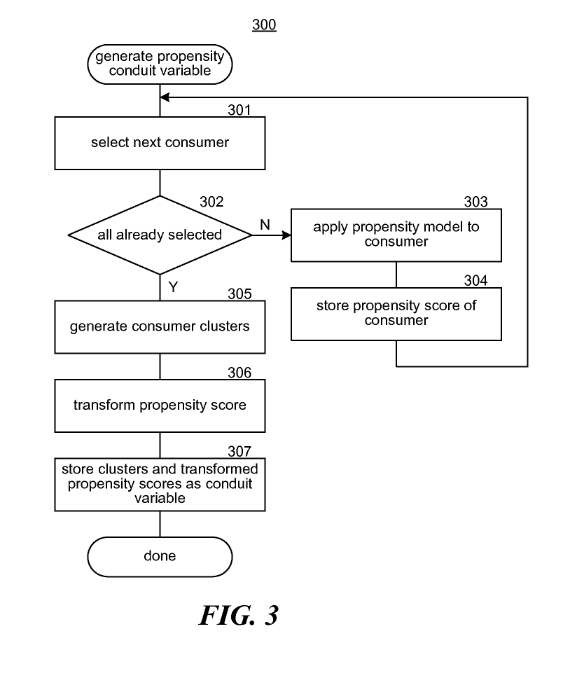

FIG. 3 is a flow diagram that illustrates the processing of a generate propensity conduit variable component of the unified model system in some embodiments. A generate propensity conduit variable component 300 uses a propensity model to generate propensity scores for consumers and then generates clusters of the consumers along with propensity scores of the clusters as the conduit variable. In blocks 301-304, the component loops generating the propensity score for each consumer. In block 301, the component selects the next consumer. In decision block 302, if all the consumers have already been selected, then the component continues at block 305, else the component continues at block 303. In block 303, the component applies the propensity model to the consumer. In block 304, the component stores the propensity score for the consumer and then loops to block 301 to select the next consumer. In block 305, the component generates clusters of the consumers based on the propensity scores and demographics of the consumers. For example, the component may use a variety of clustering techniques such as k-means clustering, expectation maximization clustering, and so on. Each cluster is represented by the values of the attributes of the consumers within the cluster. (See, Table 1.) In block 306, the component may transform the propensity scores based on a custom transformation to more accurately reflect propensity. For example, a propensity model may generate a score in the range of 0 to 1. Analysis of the propensity model may indicate that propensity scores below 0.2 and above 0.8 each represent an insignificant difference in propensity. In such a case, the custom transformation may set scores below 0.2 to 0.0, scores above 0.8 to 1.0, and uniformly distribute scores between 0.2 and 0.8 between 0.0 and 1.0. In block 307, the component stores characteristics of the clusters and the transformed propensity scores as the conduit variable. The component then completes.

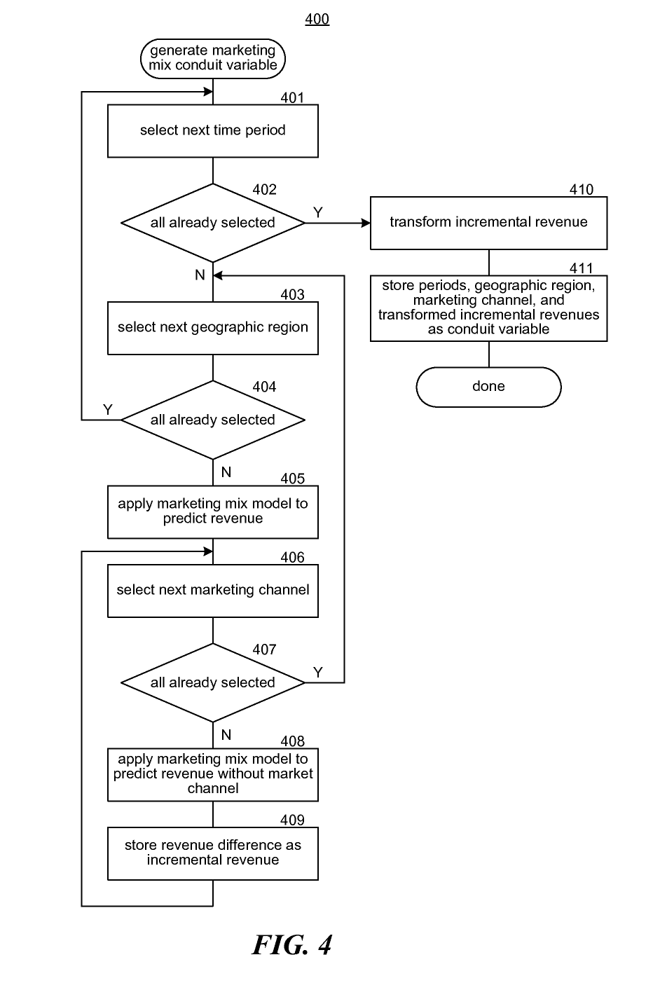

FIG. 4 is a flow diagram that illustrates the processing of a generate marketing mix conduit variable component of the unified model system in some embodiments. The generate marketing mix conduit variable component 400 generates a conduit variable that, for each time period and geographic region, provides the incremental revenue for each marketing channel. (See, Table 2.) The component loops for each time period, geographic region, and marketing channel and identifies the incremental revenue. In block 401, the component selects the next time period. In decision block 402, if all the time periods have already been selected, then the component continues at block 410, else the component continues at block 403. In block 403, the component selects the next geographic region for the selected time period. In decision block 404, if all the geographic regions have been selected for the selected time period, then the component loops to block 401 to select the next time period, else the component continues at block 405. In block 405, the component applies the marketing mix model to generate a prediction of the revenue for the selected time period and the selected geographic region. In blocks 406-409, the component loops determining the incremental revenue for each marketing channel. In block 406, the component selects the next marketing channel. In decision block 407, if all the marketing channels have already been selected, then the component continues at block 403 to select the next geographic region for the selected time period, else the component continues at block 408. In block 408, the component applies the marketing mix model to predict the revenue without the selected marketing channel. In block 409, the component stores the incremental revenue for the selected marketing channel as the difference between the total predicted revenue for all marketing channels and the predicted revenue without the selected marketing mix channel. The component then loops to block 406 to select the next marketing channel. In block 410, the component transforms the incremental revenue using a custom transformation as appropriate. In block 411, the component stores the time periods, geographic region, marketing channel, and the transformed incremental revenue for each marketing channel as the conduit variable and then completes.

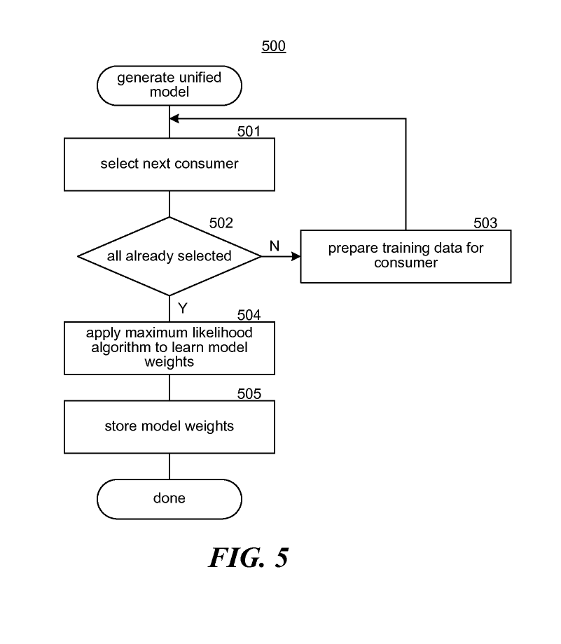

FIG. 5 is a flow diagram illustrating the processing of a generate unified model component of the unified model system in some embodiments. The generate unified model component 500 learns the model weights that best fit the training data. In block 501, the component selects the next consumer. In decision block 502, if all the consumers have already been selected, then the component continues at block 504, else the component continues at block 503. In block 503, the component prepares the training data for the selected consumer and loops to block 501 to select the next consumer. In block 504, the component applies a maximum likelihood algorithm based on the training data and the conduit variables to learn the model weights. In block 505, the component stores the model weights and completes.

Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims. Accordingly, the invention is not limited except as by the appended claims.

I/We claim:

1. A method, performed by a computer system having a memory and a processor, for constructing a unified marketing model, the method comprising:
for each of a plurality of contributing models, generating a conduit variable from the contributing model by,
for each of a plurality of values for input parameters of the contributing model, applying the contributing model to the values of the input parameters to generate a corresponding value for an output parameter of the contributing model; and
generating metrics from the input parameters and the values of the output parameters, wherein the metrics correspond to the conduit variable from the contributing model; and
generating the unified marketing model based at least in part on the generated conduit variables from each of the plurality of the contributing models and a mapping of the values of the input parameters of the contributing models for individual consumers to marketing scores for the individual consumers wherein the generated unified marketing model is adapted to receive values for input parameters of the contributing models for a target consumer and generate a marketing score for the target consumer.

2. The method of claim 1 wherein the contributing model is a consumer level model and another contributing model is an aggregated model.

3. The method of claim 1 wherein generating the unified marketing model applies a regression analysis to determine a weighting factor for each of the conduit variables and sequence features known at an individual consumer level.

4. The method of claim 1 wherein when the contributing model is a marketing mix model, generating the conduit variable for the marketing mix model generates, for each marketing channel, a time series of a mapping of change in spend for that marketing channel.

5. The method of claim 1 wherein when the contributing model is a propensity model, generating the conduit variable for the propensity model generates, for different sets of values for input parameters, a mapping of the values to a propensity score.

6. The method of claim 5 wherein generating the conduit variable for the propensity model includes generating clusters of consumers with similar attributes and propensities.

7. The method of claim 1 wherein the unified model is generated based at least in part on sequence features known at an individual consumer level including frequency and recency of marketing activity.

8. A method for applying a unified marketing model to refine a contributing model, the method comprising:
for each of a plurality of consumers, applying the unified marketing model to values for the consumer for parameters used to generate the unified marketing model, wherein the unified marketing model is generated using conduit variables from contributing models and training data;
evaluating a contributing model to determine whether results of the contributing model are consistent with the results of the unified marketing model; and
adjusting the contributing model so that the results of the contributing model are more consistent with the results of the unified marketing model.

9. The method of claim 8 wherein the conduit variables for the contributing models are generated by:
for each of a plurality of values for input parameters of the contributing model, applying the contributing model to the values of the input parameters in order to generate a corresponding value for an output parameter of the contributing model; and
generating metrics from the input parameters and the values of the output parameters, wherein the metrics correspond to the conduit variables from the contributing model.

10. The method of claim 9 wherein the contributing model is a consumer level model and another contributing model is an aggregated model.

11. The method of claim 8 wherein when the contributing model is a marketing mix model, generating the conduit variable for the marketing mix model generates, for each marketing channel, a time series of a mapping of change in spend for that marketing channel.

12. The method of claim 8 wherein when the contributing model is a propensity model, generating the conduit variable for the propensity model generates, for different sets of values for input parameters, a mapping of the values to a propensity score.

13. A computer system for constructing a unified marketing model, the computer system comprising:
a memory storing computer-executable instructions for controlling a computer system to:
generate conduit variables from the contributing models by applying a contributing model to the values of the input parameters in order to generate a corresponding value for an output parameter of the contributing model as well as metrics from the input parameters and the values of the output parameters, wherein the metrics correspond to the conduit variable from the contributing model; and
generate the unified marketing model based at least in part on the generated conduit variables from the contributing models and a mapping of the values of input parameters of the contributing models for individual consumers to marketing scores for the individual consumers; and
a processor for executing the computer-executable instructions stored in the memory.

14. The computer system of claim 13 wherein the contributing model is a consumer level model and another contributing model is an aggregated model.

15. The computer system of claim 13 wherein the computer-executable instructions that generate the unified marketing model apply a regression analysis to determine a weighting factor for each of the conduit variables.

16. The computer system of claim 13 wherein when the contributing model is a marketing mix model, the computer-executable instructions generate the conduit variable that includes, for each marketing channel, a time series of a mapping of change in spend for that marketing channel to change in result.

17. The computer system of claim 13 wherein when the contributing model is a propensity model, the computer-executable instructions generate the conduit variable for the propensity model that includes, for different sets of values for input parameters, a mapping of the values to a propensity score.
